(19) United States
(12) Patent Application Publication
(10) Pub. No.: US 2024/0354564 A1
(43) Pub. Date: Oct. 24, 2024

(54) TRAINABLE CROSS-REACTIVE FLUID SENSOR ARRAY

(71) Applicant: INTERNATIONAL BUSINESS MACHINES CORPORATION, Armonk, NY (US)

(72) Inventors: Alexander Reznicek, Troy, NY (US); Bahman Hekmatshoartabari, White Plains, NY (US); Jeremy R. Fox, Georgetown, TX (US); Martin G. Keen, Cary, NC (US)

(21) Appl. No.: 18/303,968

(22) Filed: Apr. 20, 2023

(51) Int. Cl. G06N 3/08

(52) U.S. Cl. CPC G06N 3/08

(57) ABSTRACT

An integrated sensor array may include a semiconductor substrate. The integrated sensor array may be arranged in multiple sensor sub-arrays formed on the substrate. Each sensor sub-array may include multiple, densely packed cross-reactive sensors. Each cross-reactive sensor of within the same sensor sub-array may be functionalized differently than each of the other cross-reactive sensor of the same sensor sub-array.

### TECHNICAL FIELD

This disclosure relates to electronic sensors, and more particularly, to integrated arrays of fluid sensors.

### BACKGROUND

Advances in integrated circuitry and microelectronics have led to the development of various types of sensors for a wide variety of uses. Fluid sensors, for example, can identify the types, constituent components, and/or concentrations of gases or liquids. Such sensors are widely used to detect the presence and/or levels of dangerous chemicals, for example. Increasingly, fluid sensors are used for non-invasive healthcare by monitoring an individual's bio-fluids. Further advances in sensing technology are likely to lead to even greater applications of fluid sensors in the future.

### SUMMARY

In one or more embodiments, a system includes an integrated sensor array formed on a semiconductor substrate. The integrated sensor array includes multiple sensor sub-arrays. Each sensor sub-array includes multiple, densely packed cross-reactive sensors that are functionalized differently from one another. The system may include one or more integrated circuits connected with the semiconductor substrate. The one or more integrated circuits operatively couple with the integrated sensor array.

In one aspect, the one or more integrated circuits include an application-specific integrated circuit that is configured to implement a machine learning model. The machine learning model may be trained to classify analytes based on output of the integrated sensor array.

In another aspect, the machine learning model generates an initial prediction based on the output of the integrated sensor array. Additionally, the one or more integrated circuits include communication circuitry that is configured to respond to the initial prediction's meeting a predetermined condition by communicating the output of the integrated sensor array to an external system. The external system generates a final prediction based on the output of the integrated sensor array.

In one or more embodiments, a method includes generating sensor measurements of a fluid with an integrated sensor array that includes multiple sensor sub-arrays. Each sensor sub-array includes multiple, densely packed cross-reactive sensors that are functionalized differently from one another. The method includes outputting a machine learning model prediction based on the plurality of sensor measurements.

In one aspect, the prediction is an initial prediction, and the method includes communicating the sensor measurements to an external system for generating a final prediction in response to the initial prediction's meeting a predetermined condition.

In another aspect, the initial prediction can indicate that the fluid is dangerous or harmful, prompting generation of a warning. Additionally, the external system can generate a final prediction confirming whether the fluid is dangerous or harmful.

In one or more embodiments, an integrated sensor array includes a semiconductor substrate and a plurality of sensor sub-arrays formed on the substrate. Each sensor sub-array includes a plurality of densely packed cross-reactive sensors. Each cross-reactive sensor of the same sensor sub-array is functionalized differently than each other cross-reactive sensor of the same sensor sub-array.

In one aspect, two or more cross-reactive sensors in different sensor sub-arrays are functionalized to sense a single, predetermined analyte.

In another aspect, at least one cross-reactive sensor of one or more sensor-subarrays is functionalized to sense more than one predetermined analyte.

This Summary section is provided merely to introduce certain concepts and not to identify any key or essential features of the claimed subject matter. Many other features and embodiments of the invention will be apparent from the accompanying drawings and from the following detailed description.

### BRIEF DESCRIPTION OF THE DRAWINGS

The accompanying drawings show one or more embodiments; however, the accompanying drawings should not be taken to limit the invention to only the embodiments shown. Various aspects and advantages will become apparent upon review of the following detailed description and upon reference to the drawings.

FIG. 1 is a cross-sectional view of an example integrated sensor array.

FIG. 2 is a schematic view of an example arrangement of sensors of the integrated sensor array of FIG. 1.

FIG. 3 illustrates an example system incorporating the example integrated sensor array of FIG. 1.

FIG. 4 illustrates an example neural network architecture implemented by the system of FIG. 3.

FIGS. 5A and 5B illustrate example configurations of systems that operatively couple integrated circuitry with the integrated sensor array of FIG. 1.

FIGS. 6A through 6E illustrate example sensors implemented in the integrated sensor array of FIG. 1.

FIG. 7 illustrates an example method that may be performed by a system that operatively couples integrated circuitry with the integrated sensor array of FIG. 1.

FIG. 8 illustrates an example implementation of a data processing system capable of processing data derived from signals generated by the integrated sensor array of FIG. 1.

### DETAILED DESCRIPTION

While the disclosure concludes with claims defining novel features, it is believed that the various features described herein will be better understood from consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to electronic sensors, and more particularly, to integrated arrays of fluid sensors. The inventive arrangements disclosed herein describe systems, methods, and structures that are capable of identifying individual constituents and mixtures of fluids. As used herein, “fluid” means a gas or a liquid whether comprising a single or multiple chemical or biological elements. In certain arrangements, the inventive arrangements utilize machine learning technologies (e.g., artificial neural networks) to classify sensor outputs generated in response to the presence of one or more predetermined types of fluids. Machine learning-based classifying can be used, for example, to detect and identify gases and/or liquids for safety monitoring, patient diagnosis, and various other health-related applications. Other applications include, for example, chemical production monitoring, as well as other types of applications.

An aspect of the inventive arrangements is a monolithically integrated array of sensors. The array may be arranged as a plurality of sub-arrays, in which each sub-array comprises a plurality of densely packed, cross-reactive sensors. Each of the sensors of a sub-array may be functionalized differently from each of the other sensors of the sub-array. As used herein, “Densely packed” means the number of sensors per unit area or distance between adjacent sensors such that the likelihood of correctly identifying a targeted analyte is greater than a predetermined threshold. The sensor dimensions may be in the range of 0.5-250.0 micrometers (μm), but smaller or larger sensors may also be used in other embodiments. In one embodiment, each sensor has a square footprint of 1.0 μm×1.0 μm (1.0 μm²), resulting in a density of 1 million sensors per square millimeter (10⁶/mm²). For reasons explained herein, the more densely packed the sensors—that is, the greater the number of sensors per unit area or the smaller the inter-sensor distances—the more likely the monolithically integrated array of sensors correctly identifies the targeted analyte, particularly at low concentrations of the targeted analyte. The targeted analyte can be a chemical or biological substance.

As used herein, “functionalization” means the sensor configuration that determines the analyte the sensor responds to. A sensor can be functionalized by treating a sensing surface of the sensor. “Cross-reactive sensor,” as used herein, means one of an array and/or sub-array of sensors that is functionalized to have a specific sensitivity to a predetermined concentration of a certain analyte while also being sensitive to at least one other analyte. A sensor functionalized for a concentration of analyte A, may generate output in the presence of cross-reactive substance B even in the absence of analyte A. In some embodiments, a cross-reactive sensor is functionalized to be reactive only with respect to the particular analyte to which that sensor has been functionalized. In many cases, however, functionalizing a sensor for a particular analyte results in that sensor being capable of sensing a plurality of different analytes, albeit with varying sensitivity levels. An array or sub-array of such sensors can be functionalized to have differential sensitivities and to function cooperatively in responding to a broad range of analytes.

Another aspect of the inventive arrangements disclosed herein is the use of densely packed cross-reactive sensors within each sub-array of monolithically integrated array of sensors. Dense packing enhances the cross-reactivity between the sensors for targeting various analytes. Densely packed sensors that are functionalized differently can generate correlated responses to an analyte in a significantly shortened time span, potentially in real or near-real time. Moreover, densely packed sensors that are functionalized differently can generate correlated responses to even small or trace amounts of the analyte. The dense packing of cross-reactive sensors additionally facilitates further the implementation of an integrated sensor array in various forms and devices, such as mobile and handheld devices.

Diverse functionalization of the cross-reactive sensors enables the response signals generated by each sensor to exhibit different characteristics (e.g., signal shape or magnitude) in response to one or more analytes owing to the unique functionalization of each sensor. In certain arrangements, this capability is used to facilitate pattern recognition using machine learning implemented in circuitry communicatively coupled with the monolithically integrated array of sensors.

In various arrangements, the monolithically integrated array of sensors is arranged in different numbers of densely packed sub-arrays. Moreover, different numbers of cross-reactive sensors can be disposed within each of the sub-arrays.

In certain embodiments, each of the plurality of sub-arrays of the monolithically integrated array of sensors is a duplicate of the other sub-arrays. Each sub-array includes the same number of densely packed cross-reactive sensors that are functionalized the same as the sensors of the other sub-arrays. The repeating pattern of identical sub-arrays offers distinct advantages. One advantage is that identically functionalized sensors in different sub-arrays are relatively more remote from one another given that each resides in a different sub-array. Thus, though identically functionalized, the sensors in separate sub-arrays are substantially less likely to exhibit correlated noise. The signal-to-noise (SNR) of the identically functionalized sensors can be improved by averaging the responses, which mitigates uncorrelated noise.

Another advantage of repeating patterns of identical sub-arrays is enhanced fault tolerance. Still another advantage, described in greater detail below, is facilitation of enhanced anomaly detection. The anomaly detection can be performed by feeding sensor-generated signals output by the monolithically integrated array of sensors to circuitry operatively coupled to the monolithically integrated array of sensors.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

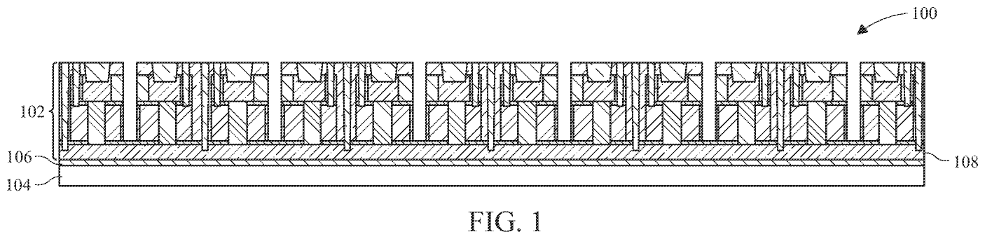

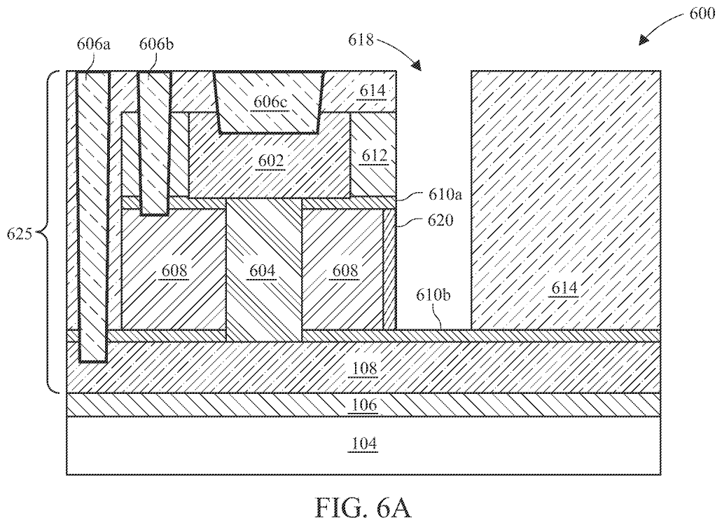

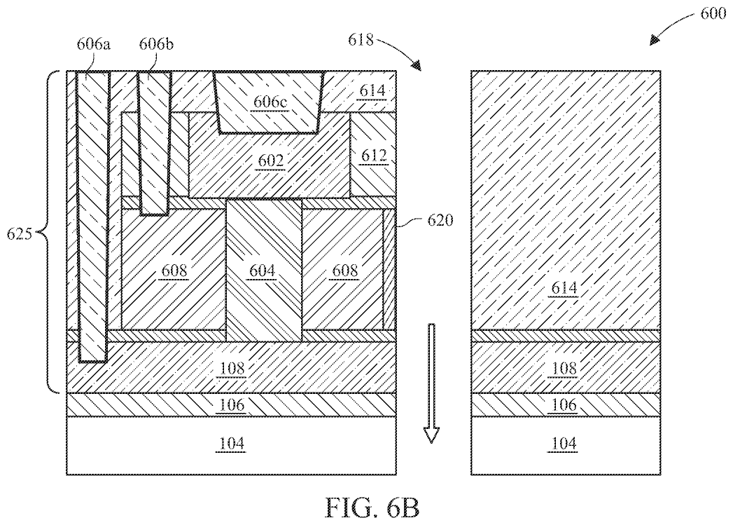

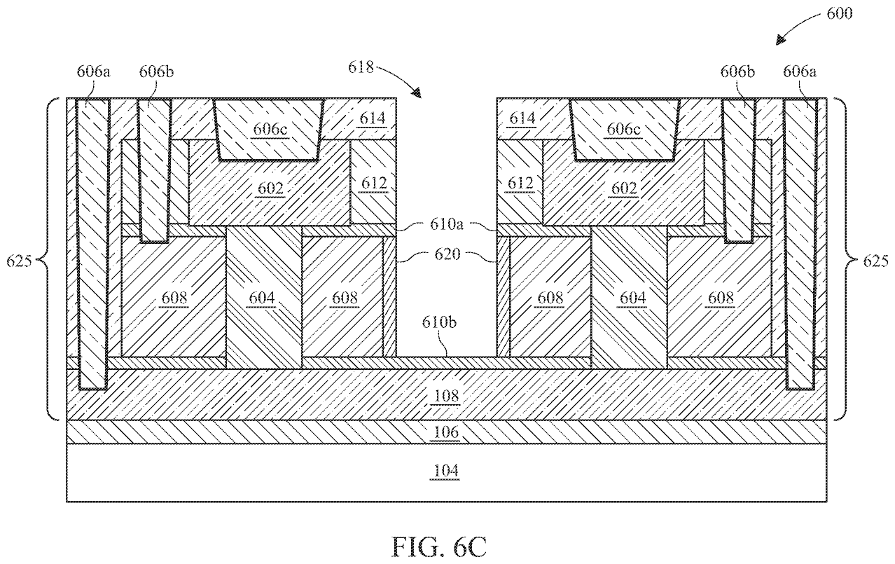

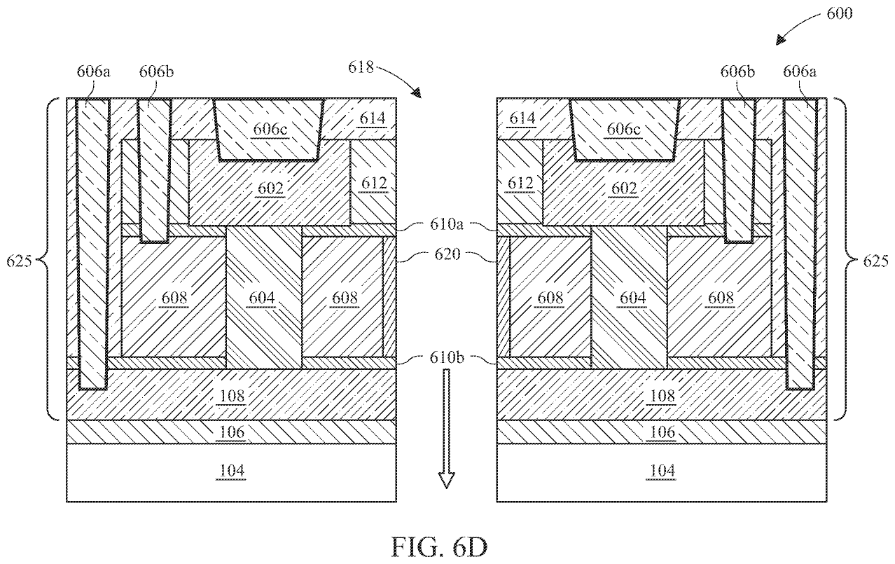

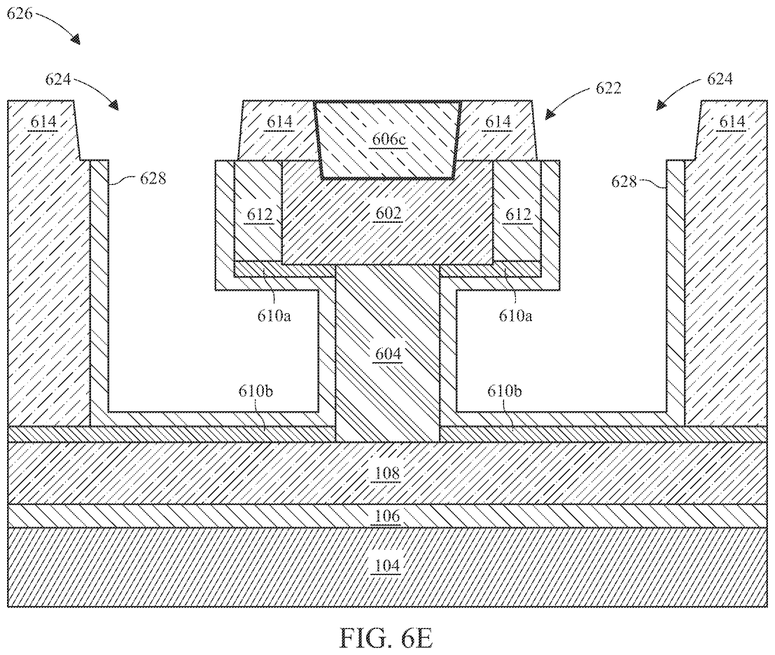

FIG. 1 is a cross-sectional view of an example integrated sensor array 100. Integrated sensor array 100 illustratively includes multiple cross-reactive sensors 102 densely packed on semiconductor substrate 104. Each of multiple cross-reactive sensors 102 is illustratively implemented with a single-column compound semiconductor bipolar junction transistor (FIG. 6A). Optionally, isolation layer 106 is interposed between emitter 108 of multiple cross-reactive sensors 102 and semiconductor substrate 104. The implementation of cross-reactive sensors 102 with single-column compound semiconductor bipolar junction transistors (BJTs) is only illustrative. In other embodiments, cross-reactive sensors 102 can be implemented with various other types of BJTs (FIGS. 6B-6E).

Cross-reactive sensors 102 also can be implemented with field effect transistors (FETs), which provide an efficient platform for manufacturing, low power consumption, and high sensitivity. In some embodiments, however, implementation of cross-reactive sensors 102 using BJTs may provide certain advantages. The BJT may provide higher SNR relative to a FET, whose sensing performance may be affected by the flicker (1/f) noise originating from the gate dielectric/silicon interface of the FET. Implementing cross-reactive sensors 102 with BJTs makes the sensors compatible with complementary metal-oxide semiconductor (CMOS) and enables their integration with silicon (Si) FETs for multiplexing and signal processing.

Cross-reactive sensors 102 can be formed on a semiconductor substrate and transferred to a glass or flexible membrane. Using different types of sensor configurations implemented with different types of BJTs or FETs, integrated sensor array 100 can be configured as either a lateral flow or a pass-through flow sensing array (FIGS. 6A-6E). Each of cross-reactive sensors 102 can be functionalized in accordance with the different surface metals (e.g., titanium (Ti), titanium nitride (TiN), tantalum (Ta), tantalum nitride (TaN), cobalt (Co), copper (Cu), gold (Au), silver (Ag), tungsten (W) that may be used to treat the sensors' sensing surfaces. Each of cross-reactive sensors 102 also can be functionalized in accordance with treatment of the sensing surfaces with one or more layers of organic molecules. In certain embodiments, at least one of cross-reactive sensors 102 can be an ion-sensitive transistor that can measure ion concentration of a liquid according to changes in electric current through the transistor. Functionalizing each of cross-reactive sensors 102 differently enhances the cross-reactivity of the sensors for targeting different analytes. Functionalized differently from one another, cross-reactive sensors 102 can generate correlated response to an analyte. Correlated responses can be generated by cross-reactive sensors 102 in response to small, or even trace, amounts of the analyte. Because cross-reactive sensors 102 are densely packed the correlated responses can be generated in a significantly shortened time span, potentially in real or near-real time.

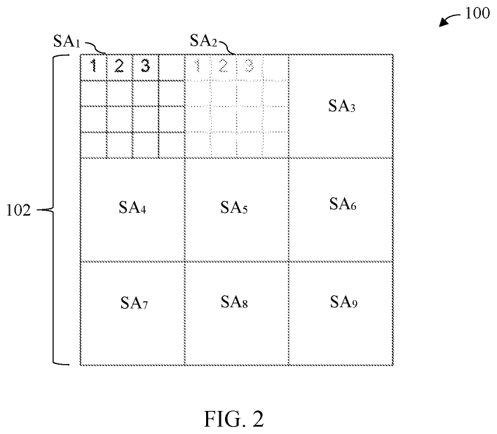

FIG. 2 illustrates an example arrangement of cross-reactive sensors 102 of integrated sensor array 100. Illustratively, in FIG. 2, cross-reactive sensors 102 are arranged in sub-arrays SA₁ through SA₉. Each of the sixteen squares in sub-array SAᵢ (i=1, . . . , 16), indicates the position of one of cross-reactive sensors 102. The arrangement and number of cross-reactive sensors 102 shown is merely illustrative. Indeed, in many if not most applications, the number of cross-reactive sensors and sub-arrays will be substantially greater, possibly numbering in the thousands or more. The arrangement of the sub-arrays, accordingly, also can vary widely, as well.

In certain embodiments, each of sub-arrays SA₁ through SA₉ is a repeat pattern that duplicates each of the other sub-arrays. For example, in FIG. 2, sensor 1 of SA₁ is functionalized identically, or nearly so, as sensor 1 of SA₂. So, too, sensors 2 and 3 of SA₁ and of SA₂, and so on for all corresponding sensors of each of sub-arrays SA₁ through SA₉. The dense packing of cross-reactive sensors within each of sub-arrays SA₁ through SA₉ facilitates cross-reactivity between the sensors for targeting various analytes, as described above. The repeated functionalization of corresponding sensors among sub-arrays SA₁ through SA₉ enhances fault tolerance, improves sensors' SNR by averaging out uncorrelated noise, and facilitates signal processing of sensor-generated signals using machine learning as described below.

In certain embodiments, two or more cross-reactive sensors of a sub-array may be functionalized to sense a single, predetermined analyte. For example, in some situations it may be especially important to detect and/or identify an analyte even at very small concentrations, such as a very toxic gas. Accordingly, multiple cross-reactive sensors within the same and/or different sub-arrays may be functionalized to detect the analyte. In certain embodiments, one or more cross-reactive sensors within one or more sub-arrays may be functionalized to detect more than one analyte. Thus, although different embodiments are preferred in different situations, in general, there is no restriction on the functionalization pattern of cross-reactive sensors 102 within a sub-array or over the entirety of integrated sensor array 100.

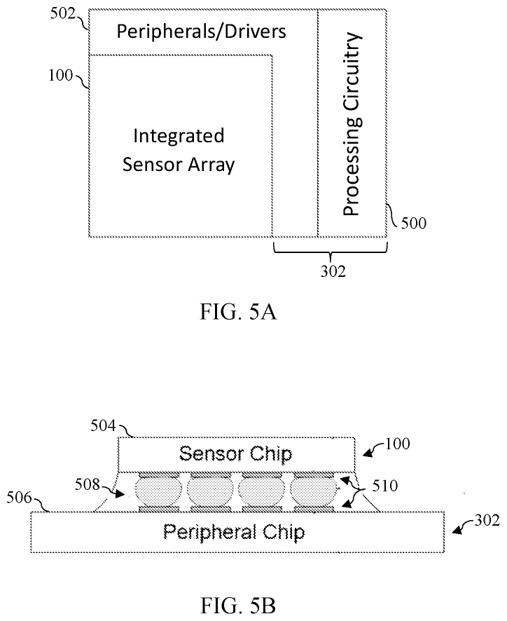

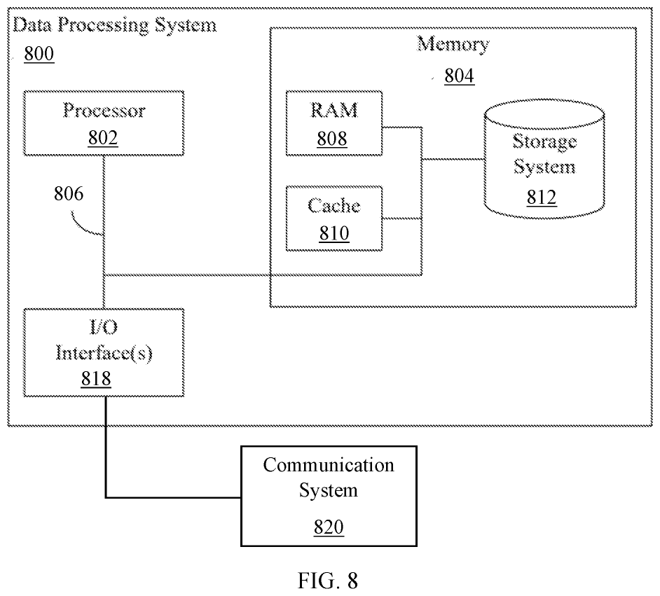

In various embodiments, integrated sensor array 100 is operatively coupled with electronic circuitry, such as an application-specific integrated circuit (ASIC). The circuitry may be monolithically integrated with integrated array sensor 100 in the same die. For example, integrated array sensor 100 may be monolithically integrated with the circuitry as a system-on-chip. Alternatively, integrated sensor array 100 and circuitry may be combined in multiple interconnected dies (e.g., in a multi-die integrated circuit implemented in a single package). Integrated sensor array 100 can be operatively coupled with and connected to circuitry in other ways as well. For example, integrated sensor array 100 can be bonded (e.g., via flip-chip bonding) to the circuitry, with the circuitry embedded in a peripheral chip bonded to a sensor chip in which integrated sensor array 100 is embedded (FIGS. 5A and 5B). In certain embodiments, the sensor chip or sensor chip/peripheral chip assembly may be integrated heterogeneously with components of a device, such as a mobile or handheld device. Operatively coupled with integrated sensor array 100, the circuitry may be configured to process signals generated by cross-reactive sensors 102, process data derived from the signals, and/or provide other functionalities, such as memory, communication, power sourcing, and the like. The circuitry can include one or more elements of a data processing system, such as the data processing system described in connection with FIG. 8. In other embodiments, the circuitry includes peripheral circuitry for supporting the processing circuitry, such as a microcontroller and/or a driver circuit for controlling one or more other processing circuit elements. The circuitry can comprise an ASIC that includes analog-to-digital converters that convert analog signals generated by cross-reactive sensors 102 into digitized data for processing by other circuitry.

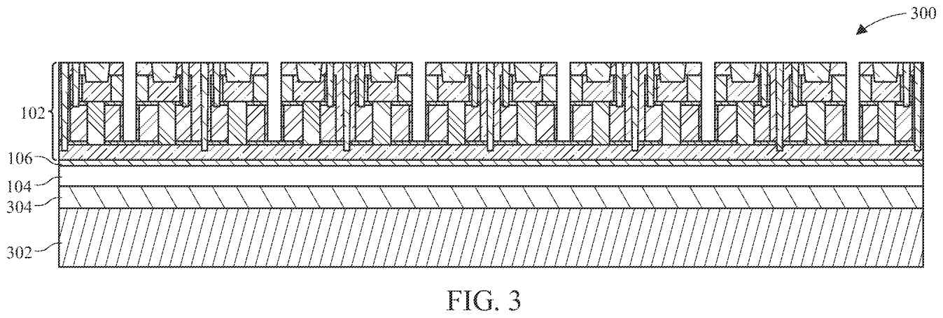

FIG. 3 illustrates an example system 300 in which integrated sensor array 100 is monolithically integrated with integrated circuitry 302. In certain embodiments, integrated circuitry 302 includes a processor and memory capable of generating machine learning model predictions (e.g., classification, regression) by processing data derived from signals generated by cross-reactive sensors 102. The machine learning model, in some embodiments, is a neural network. System 300, in certain embodiments, includes bonding layer 304. Bonding layer 304 bonds integrated circuit 302 to integrated sensor array 100 to form system 300.

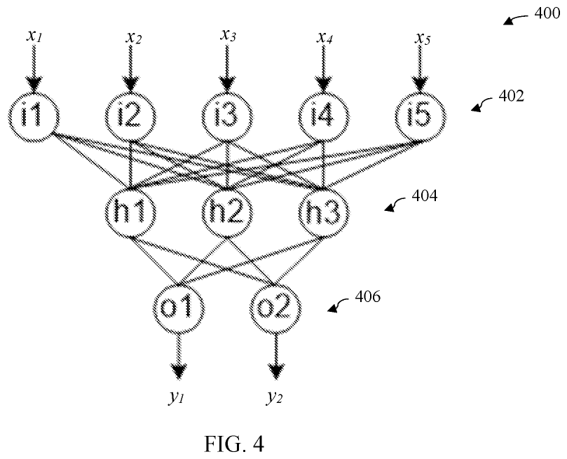

FIG. 4 schematically illustrates the architecture of an example neural network 400 implemented by system 300. Illustratively, neural network 400 includes input layer 402, hidden layer 404, and output layer 406. Input layer 402 illustratively includes nodes i1, i2, i3, i4, and i5. Hidden layer 404 illustratively includes nodes h1, h2, and h3. Output layer 406 illustratively comprises nodes o1 and o2. Neural network 400 generates outputs y₁ and y₂ in response to inputs x₁, x₂, x₃, x₄, and x₅. If, for example, system 300 is configured to predict whether a fluid sensed by cross-reactive sensors 102 is toxic (e.g., poisonous gas or pathogen), then outputs y₁ and y₂ may be model-determined probabilities that the fluid is toxic or not toxic, respectively. If the probability of toxicity is greater than a predetermined threshold (e.g., 50 percent), then system 300 classifies the fluid as toxic. Circuitry 302 optionally may include an alarm generating circuit for outputting a warning if the fluid is classified as toxic. In other embodiments, output layer 406 may include only one node or more than two nodes. For example, with three or more output nodes, neural network 400 may be configured to generate probabilities of the identity of a fluid, where each output is the probability that the fluid has a specific identity. Neural network 400, therefore, identifies the fluid based on which output yields the highest probability. Neural network 400 is merely illustrative. It is likely that in many applications the number of hidden layers is greater than one. The number of nodes per a given layer can also vary considerably depending on the classification task that the neural network is configured to perform.

Inputs x₁, x₂, x₃, x₄, and x₅ to neural network 400 may be quantities sampled from sensor measurements generated by cross-reactive sensors 102. In this regard, the number of inputs to neural network 400 is correlated with the number of sensors 102 of sensor array 100 and, more particularly, with the number of signals output from sensor array 100. The sensor measurements, for example, can include voltages and/or readout currents measured and then digitized by one or more analog-to-digital converters implemented with additional elements of integrated circuitry 302. The sensor measurements, for example, can include features extracted from the measurements using signal processing techniques performed with integrated circuitry 302. The features may include output impedance, self-gain, and/or subthreshold slope, for example. In some embodiments, more than one measured and/or feature are collected per sensor. The number of nodes of the input layer of the neural network may exceed the number of cross-reactive sensors 102. For example, if output voltages and subthreshold slopes are both collected from each sensor and fed into neural network 400, then the number of nodes of the input layer of neural network 400 is twice the number of cross-reactive sensors 102. When the extracted features are uncorrelated, they provide additional information whereas when they are correlated, they provide redundancy. Physically meaningful features may be partly correlated and partly uncorrelated. In general, the features comprise distinct patterns that correspond to one or more fluids or mixtures. Neural network 400 can be trained using machine learning to classify the patterns. Based on the classifying, system 300 determines one or more predetermined characteristics of the fluid(s) or mixture(s) (e.g., whether the fluid is a toxic gas or unhealthy biofluid).

In certain embodiments, the neural network computation is performed by an inference engine implemented as an application-specific integrated circuit (ASIC) which is either fabricated monolithically with a sensor chip in which integrated sensor array 100 is embedded, or is fabricated separately and integrated heterogeneously (e.g., bonded to the sensor chip), as illustrated in FIGS. 5A and 5B.

In other embodiments, circuitry 302 of system 300 comprises wired and/or wireless communication engine or circuitry. The communication circuitry may be configured to convey signals generated by cross-reactive sensors 102 of integrated sensor array 100 to a cloud-based system, such as a data processing system described in connection with FIG. 8 albeit implemented in the cloud. The cloud-based system can perform neural network computation based on signals generated by cross-reactive sensors 102. The wired and/or wireless communication engine or circuitry may be integrated either monolithically or heterogeneously with integrated sensor array 100 for conveying sensor signals or data derived therefrom via a wired or wireless connection to the cloud-based system.

In yet other embodiments, neural network predictions are performed both at the edge by system 300 and in the cloud by a cloud-based system. For instance, a coarse, typically less accurate, neural network classification is initially performed by system 300 to warn of possible exposure to a potentially toxic gas or harmful pathogen. The warning is generated rapidly in response to a possible danger even though the initial prediction prompting the warning may be a false positive. A subsequent prediction for which the confidence level of its accuracy is greater is performed by the cloud-based system. Although more accurate, the classification by the cloud-based system is performed more slowly. It also may be potentially delayed due to network connectivity issues given that the prediction is performed in the cloud. The rapid coarse prediction followed by a more accurate though delayed prediction offers distinct advantages. In real time, likely exposure of facility personnel to a possible hazard is reduced, but over time, the cost of prolonged shutdown of the facility (e.g., of an industrial or medical facility) is mitigated if, in fact, the fluid detected by system 300 is not harmful.

In further embodiments, system 300 may be configured as a wall-mounted alert system, whereby integrated sensor array 100 is embedded in a sensor chip or in a sensor chip/peripheral chip assembly. The assembly may be mounted on a motherboard. The neural network computation may be performed on a general-purpose central processing unit (CPU), graphical processing unit (GPU), a custom-designed hardware accelerator or a combination thereof.

Prior to initiating operation, system 300 can be prepared by training neural network 400. Neural network 400 may be trained using data derived from measuring the response of cross-reactive sensors 102 to various gas mixtures of known toxicity and adjusting neural network 400's parameters to minimize the error in the classification results. The training may be performed using known machine learning techniques such as back-propagation. For example, with four gases (1, 2, 3, and 4) provided for training, there are 2⁴−1=15 combinations of these gases (1, 2, 3, 4, 1-2, 1-3, 1-4, 2-3, 2-4, 3-4, 1-2-3, 1-2-4, 1-3-4, 2-3-4, 1-2-3-4). The ratios can be varied for each mixture. For example, the mixture ratio may be 50 percent for gas 1 and 50 percent for gas in one training example, and 10 percent for gas 1 and 90 percent for gas in another. Using machine learning techniques to train neural network 400, system 300 can classify fluids and/or mixtures not encountered during training.

Although training may be a resource-intensive task, it needs to be performed only once, on a prototype, for example, and then the prototype can be mass produced. The training can be performed on general-purpose GPUs and/or custom-designed hardware accelerator platforms. As needed, system 300 can be calibrated to compensate for variability in manufacturing. Subsequent training is likely significantly less resource-intensive than the original training given that re-training may only be needed with respect to the first or the first few layers of neural network 400 and/or necessitate use of only a small fraction of training examples. Recalibration, if needed over time, can also be performed using limited retraining, and full retraining, if needed (e.g., owing to the new technology), is also less resource-intensive than original training. Transfer learning may be utilized to customize system 300, which also requires fewer training resources than did the original training of system 300.

FIGS. 5A and 5B illustrate example configurations of systems that operatively couple integrated sensor array 100 with circuitry 302, which may be configured in various ways to provide different types of functionalities. Circuitry 302 comprises processing circuitry for processing the output of integrated sensor array 100, the output including sensor-generated signals and/or data derived therefrom. Thus, circuitry 302 may include one or more processors capable of executing program code, programmable circuitry such as programmable logic (e.g., configurable), one or more graphics processing units, and/or dedicated and hardened circuitry configured to implement one or more machine learning models.

In FIG. 5A, integrated sensor array 100 is monolithically integrated with circuitry 302, which illustratively includes signal and data processing circuitry 500 that may be controlled by peripherals/drivers circuitry 502 interposed between processing circuitry 500 and integrated sensor array 100. In FIG. 5B, integrated sensor array 100 is embedded in sensor chip 504 and is operatively coupled with peripheral chip 506, in which processing circuitry 302 is embedded. Sensor chip 504 is illustratively bonded to a peripheral chip 506. In certain embodiments, sensor chip 504 is bonded to peripheral chip 506 using flip-chip bonding. As illustrated in FIG. 5B, sensor chip 504 may be bonded to peripheral chip 506 using solder balls 508 disposed within an underfill between metal pads 510 on both sensor chip 504 and peripheral chip 506. In other embodiments, sensor chip 504 and peripheral chip 506 are connected by placing the sensor chip 504 and peripheral chip 506 dies on an interposer and/or by using bridge circuits. Sensor chip 504 (with or without a bonded chip) may be integrated heterogeneously (e.g., with separately manufactured components) into a higher-level assembly, such as a System-in-Package (SIP). The SIP may be embedded, for example, a handheld/portable device. The dense packing of cross-reactive sensors 102 further facilitates implementing integrated sensor array 100 in various forms and devices, such as mobile and handheld devices.

FIGS. 6A-6E illustrate example embodiments of cross-reactive sensors 102. In FIGS. 6A-6D, each sensor 600 of cross-reactive sensors 102 is implemented with a BJT 625. In FIG. 6E cross-reactive sensors 102 are biosensors, in which each biosensor 626 includes BJT 622.

In FIGS. 6A and 6B, BJT 625 comprises negatively doped (n⁺) emitter 108 and collector 602, intrinsic base 604, and contacts 606a, 606b, and 606c. Intrinsic base 604 is encased by heavily doped extrinsic base 608, which is interposed between top spacer 610a and bottom spacer 610b. Collector 602 is encased by oxide 612. In FIG. 6A, sample trench 618 for receiving fluid extends between sensing surface 620 and interlevel dielectric (ILD) 614. The sensor 600 with BJT 625 in FIG. 6A is configured as a lateral flow sensor in which fluid flows over the sensor, and thus sample trench 618 extends only to bottom spacer 610b above emitter 108. The sensor 600 with BJT 625 in FIG. 6B is configured as a pass-through flow sensor in which fluid flows through the sensor, and thus sample trench 618 extends through emitter 108, isolation layer 106, and substrate 104.

In FIGS. 6C and 6D, sensor 600 is implemented with two separate BJTs 625, each as already described. FIG. 6C corresponds to FIG. 6A, and FIG. 6D corresponds to FIG. 6B. Sensor 600 with BJT 625 in FIG. 6C is configured as a lateral flow sensor in which fluid flows over the sensor, and thus sample trench 618 extends only to bottom spacer 610b above emitter 108. Sensor 600 with BJT 625 FIG. 6D is configured as a pass-through flow sensor in which fluid flows through the sensor, and thus sample trench 618 extends through emitter 108, isolation layer 106, and substrate 104.

FIG. 6E illustrates cross-reactive sensors 102 as biosensors, each biosensor 626 comprising BJT 622 within sensing channel 624. BJT 622 of biosensor 626 is configured with a dielectric layer 628 which serves as a sensing surface. The surface of the dielectric layer 628 is chemically treated to specifically bond to one or more selected biomolecules. Features of the BJT-implemented sensors illustrated in FIGS. 6A-6D include a vertically oriented stack of an emitter overlying a supporting substrate, a base region atop the emitter, and a collector atop the base region. Features of the biosensor of FIG. 6E include a bulk substrate and a vertical BJT formed on at least a portion of the substrate. These are only examples of BJT structures that may be used in integrated sensor array 100, however. In other embodiments, integrated sensor array 100 may include differently structured BJTs. Moreover, although cross-reactive sensors 102 have been described primarily as BJT-implemented sensors and BJT-containing biosensors, other types of cross-reactive sensors 102 can be used. These other types of cross-reactive sensors, for example, can include sensors implemented using FETs or CMOS transistors. The other types of cross-reactive sensors may be used to generate signals from which machine learning model data can be derived, the data for generating with a machine learning model (e.g., neural network) a prediction (e.g., classification, regression) pertaining to an analyte sensed by an integrated sensor array as disclosed herein.

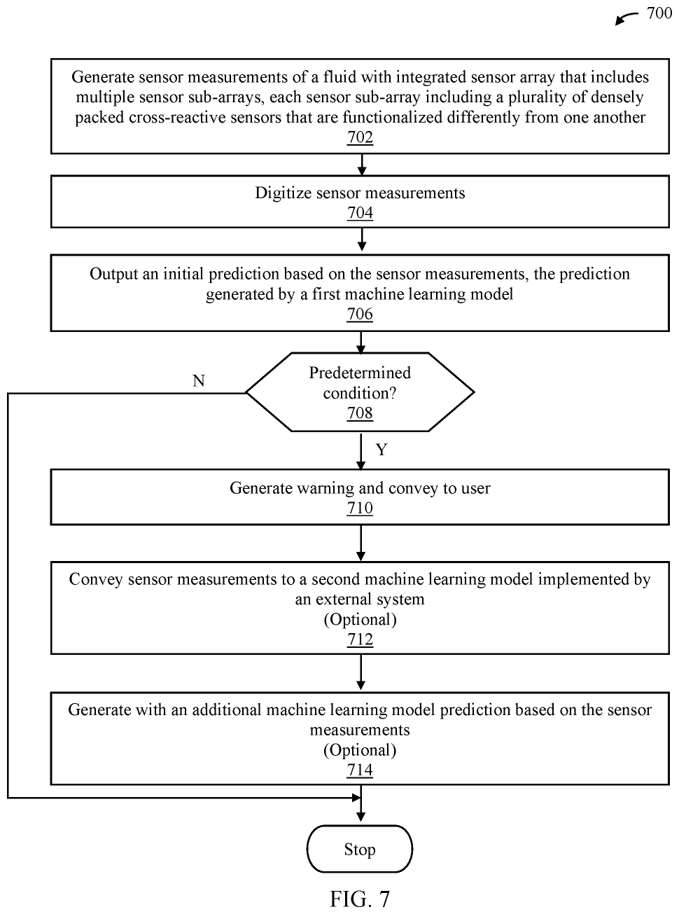

FIG. 7 illustrates an example method 700 that may be performed by a system such as system 300. The system can include an integrated sensor array and circuitry as described in connection with FIGS. 1-6.

In block 702, the system generates sensor measurements of a fluid. The system may generate the sensor measurements with an integrated sensor array. The integrated sensor array may include multiple sensor sub-arrays, each sensor sub-array including a plurality of densely packed cross-reactive sensors that are functionalized differently from one another.

In block 704, the system optionally digitizes the sensor measurements. Digitizing the sensor measurements facilitates generating data having specific structures that are processed by a system that implements a model. The model may be trained using machine learning to generate predictions (e.g., classifications, regressions) based on the data. For example, the model prediction can identify the fluid. The model prediction, for example, can indicate whether the fluid is harmful (e.g., a toxic gas or dangerous pathogen).

In block 706, the system outputs the machine learning model prediction generated based on the sensor measurements. The prediction, in some embodiments, is generated by circuitry operatively coupled to the integrated sensor array. For example, the circuitry may be monolithically integrated with the integrated sensor array or otherwise connected with the integrated sensor array (e.g., embedded in a chip bonded to the integrated sensor array). The circuitry may implement a machine learning model (e.g., neural network) trained to generate machine learning model predictions based on the sensor measurements.

In certain embodiments, the machine learning model prediction is a preliminary prediction. If, for example, the system is implemented in a limited-space device (e.g., mobile or handheld device), the circuitry may have limited processing and/or memory capabilities for implementing a neural network or other machine learning model. Accordingly, the system may include communication circuitry or communicatively couple with communication circuitry in which the system is implement, the communication circuitry used by the system to convey the sensor measurements (or digitized data derived therefrom) to an external system.

In block 708, the system optionally determines whether the model prediction determined by the system meets a predetermined condition. The predetermined condition may be a pattern of sensor measurements (or features extracted therefrom) that indicate a likelihood of a dangerous condition (e.g., toxic gas or pathogen).

If at block 708, the system determines that the predetermined condition for the fluid is met, then a block 710, the system may generate a warning. The system's circuitry or that of the device in which the system is implemented may be utilized by the system to convey the warning to the user. The system, for example, may generate a visual warning on a graphical user interface of the device and/or convey an audible warning via a speaker of the device.

Optionally, in block 712, if the condition is met as block 708, the system can utilize communication circuitry described above to convey the sensor measurements to an external system to confirm the prediction that prompted the warning. The external system may be a data processing system such as that described in connection with FIG. 8. The external system may be a cloud-based system, an off-chip device, or other integrated circuitry apart from the system operatively coupled to the integrated sensor array. The external system may have greater processing resources (e.g., CPU, GPU, memory). The external system thus may implement a second, more sophisticated machine learning model for providing an additional prediction having a higher confidence level.

Thus, optionally, in block 714 an additional, post-warning machine learning model prediction may be generated by the external system. The prediction generated by the external system can confirm whether the earlier prediction made by the system was likely correct or more likely a false positive. The additional machine learning model prediction is based on the sensor measurements conveyed by the system to the external system. Given greater processing resources, the external system may implement a more sophisticated machine learning model. For example, given a larger memory of the external system, the machine learning model implemented by the external system may be trained using supervised learning with a much larger set of training examples. Accordingly, the additional machine learning model prediction generated by the external system may have a greater confidence level.

In certain embodiments, the system may generate a prediction in relatively rapid time. Moreover, the system may be implemented on a mobile or handheld device. Both the size of the device and the rapidity with which the device-implemented system generates a prediction are distinct advantages. The device, for example, can be conveniently carried even in difficult to reach spaces. The rapid prediction can be used to provide timely warning of a dangerous biohazard or toxic gas, for example. The same factors of size and/or time that provide distinct advantages, however, may mean that the rapid prediction of a dangerous fluid is more prone to be a false positive. Conveying the same sensor measurements to the external system enables an additional prediction that can confirm the accuracy of the system's initial prediction or determine that it is merely a false positive. Thus, a benefit is that the system is able to generate a timely warning-even though it may be a false positive—while taking advantage of additional capabilities of the external system for making a more reliable determination when an immediate danger is passed.

FIG. 8 illustrates an example implementation of a data processing system 800. As defined herein, the term “data processing system” means one or more hardware systems configured to process data, each hardware system including at least one processor and memory, wherein the processor is programmed with computer-readable instructions that, upon execution, initiate operations. Data processing system 800 can include a processor 802, a memory 804, and a bus 806 that couples various system components including memory 804 to processor 802.

Processor 802 may be implemented as one or more processors. In an example, processor 802 is implemented as a central processing unit (CPU). Processor 802 may be implemented as one or more circuits capable of carrying out instructions contained in program code. The circuit may be an integrated circuit or embedded in an integrated circuit. Processor 802 may be implemented using a complex instruction set computer architecture (CISC), a reduced instruction set computer architecture (RISC), a vector processing architecture, or other known architectures. Example processors include, but are not limited to, processors having a 10×6 type of architecture (IA-32, IA-64, etc.), Power Architecture, ARM processors, and the like.

Bus 806 represents one or more of any of a variety of communication bus structures. By way of example, and not limitation, bus 806 may be implemented as a Peripheral Component Interconnect Express (PCIe) bus. Data processing system 800 typically includes a variety of computer system readable media. Such media may include computer-readable volatile and non-volatile media and computer-readable removable and non-removable media.

Memory 804 can include computer-readable media in the form of volatile memory, such as random-access memory (RAM) 808 and/or cache memory 810. Data processing system 800 also can include other removable/non-removable, volatile/non-volatile computer storage media. By way of example, storage system 812 can be provided for reading from and writing to a non-removable, non-volatile magnetic and/or solid-state media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 806 by one or more data media interfaces. Memory 804 is an example of at least one computer program product.

Memory 804 is capable of storing computer-readable program instructions that are executable by processor 802. For example, the computer-readable program instructions can include an operating system, one or more application programs, other program code, and program data. The computer-readable program instructions may be executable by a system including integrated sensor array 100 or by a cloud-based system to implement a machine learning model (e.g., neural network classifier). Processor 802, in executing the computer-readable program instructions, is capable of performing the various operations described herein that are attributable to a computer, including performing neural network computations described in connection with FIG. 3 and operations described herein in connection with method 700 of FIG. 7. It should be appreciated that data items used, generated, and/or operated upon by data processing system 800 are functional data structures that impart functionality when employed by data processing system 800. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor. Examples of data structures include images and meshes.

Data processing system 800 may include one or more Input/Output (I/O) interfaces 818 communicatively linked to bus 806. I/O interface(s) 818 allow data processing system 800 to communicate with one or more external devices and/or communicate over one or more networks such as a local area network (LAN), a wide area network (WAN), and/or a public network (e.g., the Internet). Examples of I/O interfaces 818 may include, but are not limited to, network cards, modems, network adapters, hardware controllers, etc. Examples of external devices also may include devices that allow a user to interact with data processing system 800 (e.g., a display, a keyboard, a microphone for receiving or capturing audio data, speakers, and/or a pointing device). Optionally, I/O interface 818 can be communicatively coupled with a communication system 820 integrated in, or external to, data processing system 800. If one or more elements of data processing system 800 comprise circuitry operatively coupled with an integrated sensor array, such integrated sensor array 100, communication system 820 can convey signals generated by the sensors of the array to a cloud-based data processing system comparable to data processing system 800 and able to execute a machine learning model (e.g., neural network).

Data processing system 800 is only one example implementation. Data processing system 800 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

The example of FIG. 8 is not intended to suggest any limitation as to the scope of use or functionality of example implementations described herein. Data processing system 800 is an example of computer hardware that is capable of performing the various operations described within this disclosure. In this regard, data processing system 800 may include fewer components than shown or additional components not illustrated in FIG. 8 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The terminology used herein is for the purpose of describing particular embodiments only and is not intended to be limiting. Notwithstanding, several definitions that apply throughout this document now will be presented.

As defined herein, the singular forms “a.” “an,” and “the” are intended to include the plural forms as well, unless the context clearly indicates otherwise.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more.” and “and/or,” are open-ended expressions that are both conjunctive and disjunctive in operation unless explicitly stated otherwise. For example, each of the expressions “at least one of A, B, and C.” “at least one of A, B. or C.” “one or more of A, B, and C.” “one or more of A, B, or C.” and “A, B, and/or C” means A alone, B alone, C alone, A and B together, A and C together, B and C together, or A, B and C together.

As defined herein, the term “automatically” means without user intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of a computer readable storage media. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, “real time” means a level of processing responsiveness that a user or system senses as sufficiently immediate for a particular process or determination to be made, or that enables the processor to keep up with some external process.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or media) having computer readable program instructions thereon for causing a processor to carry out aspects of the present invention. Within this disclosure, the term “program code” is used interchangeably with the term “computer readable program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. An integrated sensor array, comprising:
a semiconductor substrate; and
a plurality of sensor sub-arrays formed on the substrate, wherein:
each sensor sub-array includes a plurality of densely packed cross-reactive sensors; and
each cross-reactive sensor of a same sensor sub-array is functionalized differently than each other cross-reactive sensor of the same sensor sub-array of the plurality of sensor sub-arrays.

2. The integrated sensor array of claim 1, wherein two or more cross-reactive sensors in different sensor sub-arrays are functionalized to sense a single, predetermined analyte.

3. The integrated sensor array of claim 1, wherein one cross-reactive sensor of one or more sensor-subarrays is functionalized to sense more than one predetermined analyte.

4. The integrated sensor array of claim 1, wherein each sub-array of the plurality of sensor sub-arrays is identical with each of the other sub-arrays.

5. The integrated sensor array of claim 1, wherein the cross-reactive sensors of each of the plurality of sub-arrays is configured as a gas sensor.

6. The integrated sensor array of claim 1, wherein a cross-reactive sensor of at least one sub-array of the plurality of sub-arrays is configured as a biosensor.

7. The integrated sensor array of claim 1, wherein a cross-reactive sensor of at least one sub-array of the plurality of sub-arrays is configured as an ion-sensitive transistor.

8. The integrated sensor array of claim 1, wherein at least one of the cross-reactive sensors of each of the plurality of sub-arrays is configured as a bipolar junction transistor.

9. The integrated sensor array of claim 1, wherein at least one of the cross-reactive sensors of each of the plurality of sub-arrays is configured as a field effect transistor.

10. A system, comprising:
a semiconductor substrate;
an integrated sensor array formed on the semiconductor substrate, wherein the integrated sensor array includes a plurality of sensor sub-arrays, and wherein each sensor sub-array includes a plurality of densely packed cross-reactive sensors that are functionalized differently from one another; and
a processing circuit operatively coupled with the integrated sensor array, wherein the processing circuit is configured to generate an indication of detected fluids based on signals generated by the integrated sensor array.

11. The system of claim 10, wherein the processing circuit implements a machine learning model trained to classify analytes based on output of the integrated sensor array.

12. The system of claim 10, further comprising:
communication circuitry configured to convey output of the integrated sensor array to a machine learning classifier implemented in external circuitry.

13. The system of claim 12, wherein the communication circuitry is configured to convey the output of the integrated sensor array wirelessly.

14. The system of claim 10, wherein the processing circuit implements a machine learning model trained to classify analytes based on output of the integrated sensor array; and
wherein the system further comprises communication circuitry configured to convey output of the integrated sensor array to a machine learning classifier implemented in external circuitry.

15. A method, comprising:
generating, by an integrated sensor array, a plurality of sensor measurements of a fluid, wherein the integrated sensor array includes a plurality of sensor sub-arrays, and wherein each sensor sub-array includes a plurality of densely packed cross-reactive sensors that are functionalized differently from one another;
processing the sensor measurements through a machine learning model to determine a prediction based on the plurality of sensor measurements; and
outputting the prediction.

16. The method of claim 15, wherein the prediction is an initial prediction, and wherein the method further comprises:
in response to the initial prediction meeting a predetermined condition, communicating the plurality of sensor measurements to an external system for generating a final prediction based on the plurality of sensor measurements.

17. The method of claim 16, further comprising:
responding to the initial prediction's meeting a predetermined condition by generating a warning.

18. The method of claim 15, wherein the machine learning model is a neural network trained to generate the prediction based on the plurality of sensor measurements.

19. The method of claim 15, wherein the prediction indicates whether the fluid is a toxic gas or a harmful biofluid.

20. The method of claim 15, further comprising:
digitizing the sensor measurements for input to the machine learning model.
